(19) United States
(12) Patent Application Publication
(10) Pub. No.: US 2007/0070198 A1
(43) Pub. Date: Mar. 29, 2007

(54) Monitoring camera system and method

(76) Inventors: Luis Vera, Santiago (CL); Eyal Shats, Vitacura - Santiago (CL)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 11/235,522

(22) Filed: Sep. 27, 2005

(51) Int. Cl. H04N 7/18; B61L 15/00

(52) U.S. Cl. 348/143; 246/166.1

(57) ABSTRACT

A surveillance system includes a track system having a first track and a second track that allow for the translation of a camera carriage having a camera. The track system may be combined to lengthen or shorten the expanse of the surveillance system. A pulley system translates the camera carriage across the surveillance system.

### FIELD OF THE INVENTION

The present invention relates generally to monitoring multiple locations within a specified area. More particularly, the present invention relates to mounting a camera on a track and being able to track objects or individuals within a specified area.

### BACKGROUND OF THE INVENTION

Closed circuit television surveillance systems have been used to provide images of a target. These systems are widely used today particularly in the retail industry and in the security industry. Many of the existing surveillance systems are mounted at a fixed location and are incapable of a wider range of movement.

To provide that wider range of coverage, rail based systems have been used, where a camera is positioned on a rail and can cover additional areas as compared to a stationary camera. However, rail based surveillance systems may be problematic.

For example, rail based systems are often expensive in that they are designed specifically for the user. The length of the rail system, may, for instance, vary with every customer. This adds great cost in that the systems have to be designed and fabricated accordingly.

Also, the rail based systems may be heavy, based on the length of the rail. There may also be repetitive maintenance in that the mechanism used to translate the camera may wear out easily. Also, the mechanism used to translate the camera may cause excessive vibration or noise.

Accordingly, it is desirable to provide a rail based surveillance system that is inexpensive, can be easily lengthened or shortened, results in low vibration or noise, and requires less maintenance in that there is less wear on the translating mechanism.

### SUMMARY OF THE INVENTION

The foregoing needs are met, to a great extent, by the present invention, wherein in one aspect an apparatus is provided that in some embodiments provides a rail based closed circuit surveillance system that is inexpensive, can be easily lengthened or shortened, results in low vibration or noise, and requires less maintenance in that there is less wear on the translating mechanism.

In accordance with one embodiment of the present invention, a surveillance system includes a track system having a first track and a second track that allow for the translation of a camera carriage disposed with a camera. The track system may be combined with additional track systems to lengthen the expanse of the surveillance system. Correspondingly, the sections of the track system may be removed to shorten the surveillance system. A pulley system translates the camera carriage across the surveillance system.

In accordance with yet another embodiment of the present invention, a first segment apparatus for aiding in providing surveillance in a specified area includes a first track that has a passageway and a rail system. A second track includes an upper conduit, a middle conduit and a lower conduit, wherein the second track is positioned within the passageway of and detachably coupled to the first track.

In accordance with yet another embodiment of the present invention, the middle conduit is configured to house a cable selected from the group consisting of a power cable, a data cable, an audio cable, and a video cable. The cable is housed in a protective housing.

In accordance with still another embodiment of the present invention, the right sidewall and the left sidewall of the middle conduit comprise a vibration insulator. The vibration insulator includes ribs.

In accordance with yet another embodiment of the present invention, the first segment further includes a camera carriage slidably connected to the first segment. The camera carriage is translated along the first segment by a pulley system that includes a pulley, a belt, an encoder, and a motor.

In accordance with another embodiment of the present invention, a dome is detachably coupled to the first track. The dome is formed from glycol-modified polyethylene terephthalate (PETG).

In accordance with yet another embodiment of the present invention, the first segment is configured to be coupled to a second segment. An upper right slot of the first segment is coupled to an upper right slot of the second segment by a first bracket; an upper left slot of the first segment is coupled to an upper left slot of the second segment by a second bracket; a lower right slot of the first segment is coupled to a lower right slot of the second segment by a third bracket; and a lower left slot of the first segment is coupled to a lower left slot of the second segment by a fourth bracket.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view illustrating a surveillance system according to a preferred embodiment of the invention.

FIG. 2 is a perspective view of a track system of the surveillance system.

FIG. 3 is a front plan view of a first track.

FIG. 4 is a front plan view of a second track in accordance with one embodiment.

FIG. 5 illustrates a front plan view of the surveillance system.

FIG. 6 is a perspective view of a camera carriage.

FIG. 7 is a perspective view of the camera carriage and the track system.

FIG. 8 is a perspective view of a first end of a pulley system according to an embodiment of the invention.

FIG. 9 is a side plan view of the first end of the pulley system.

FIG. 10 is a perspective view of a second end of the pulley system.

FIG. 11 is a front plan view of a belt of the pulley system.

FIG. 12 is a perspective view of a protective housing.

FIG. 13 is a side plan view of a link of the protective housing.

FIG. 14 is a top plan view of the link.

FIG. 15 is a perspective view of a counterweight used with the surveillance system.

FIG. 16 is a perspective view of the counterweight.

FIG. 17 is a top view of the counterweight at a first position.

FIG. 18 is a top view of the counterweight at a second position.

### DETAILED DESCRIPTION

The invention will now be described with reference to the drawing figures, in which like reference numerals refer to like parts throughout. An embodiment in accordance with the present invention provides a rail based surveillance system that is inexpensive, can be easily lengthened or shortened, results in low vibration or noise, and requires less maintenance for components such as, but not limited, to the translating mechanism.

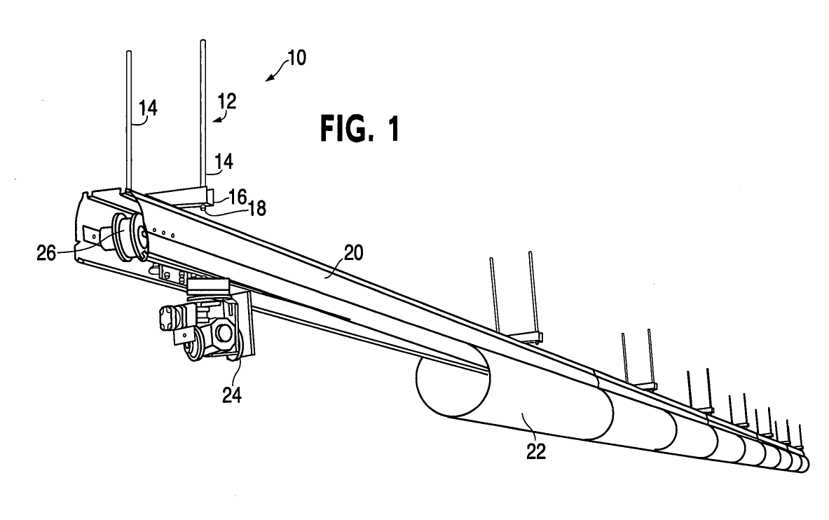

FIG. 1 is a perspective view of a surveillance system 10, according to an embodiment of the present invention. The surveillance system 10 provides surveillance in a specified area as desired. The surveillance system 10 may be used in any location, such as for example, airports, streets, warehouses retail stores. The surveillance system 10 attaches to a surface, for example, a wall or a ceiling, by way of a ceiling fixture 12. The ceiling fixture 12 has legs 14 that extend from a ceiling bracket 16. The ceiling bracket 16 couples to the legs by way of fasteners 18 and couples to the surveillance system 10 by way of additional fasteners (not shown). The ceiling fixture 12 may be bolted or screwed to the surveillance system 10. Alternately, it may be attached through welding or an adhesive structure on to the surveillance system 10.

The fasteners 18 may be any type of fastening device, for example, screws or bolts. Alternatively, the system may be fastened to the ceiling or wall, ensuring that the surveillance system 10 is fixed to a specified location.

The surveillance system 10 includes a track system 20 that couples to a dome 22. The dome 22 encloses a camera carriage 24 slidably coupled to the track system 20. The camera carriage 24 is translated across the track system 20 by a pulley system 26.

The surveillance system 10 is formed using several sections of the track system 20 that may be joined together. The individual sections are substantially similar in configuration and may or may not be identical in length. These sections may be assembled together to form a particular length of the surveillance system 10.

The dome 22 may be made of a plastic such that an observer may not see what is behind the dome 22, but a camera within the dome may easily record the surroundings. The dome 22 may thus be transparent. The dome 22 provides the ability to acquire and follow a target without the target being aware that it is the target of such an acquisition. However, use of the dome 22 is optional, as is desired by a customer. The dome 22 may also be referred to as a globe or any type of enclosure.

Further, the dome 22 may be formed from any suitable transparent material. Alternately, the dome 22 may be formed from any transparent plastic material. In particular, acrylics may be used or a plastic—such as for example, a plastic poly-carbonate film that has polarized film adhered by, for example, glue to the plastic. In particular, dome 22 may be formed from glycol-modified polyethylene terephthalate (PETG). PETG is a thermoplastic co-polyester that is a clear amorphous thermoplastic. PETG has high stiffness, hardness and toughness. It has been compared to optical glass for the transparency and extreme clarity it provides.

Although the dome 22 is illustrated in a circular fashion, any particular shape or configuration may be used. The dome 22 may have a U-shape, for example, with the sides of the U mating with the track system 20.

The dome 22 also protects the camera carriage 24 from debris. Debris may be harmful to the surveillance system 10 for several reasons. First, debris may collect on the tracks and deter the smooth translation of the camera carriage 24 on the track system 20. Further, debris may collect on the pulley system 26 and prevent the pulley system 26 from functioning properly. Lastly, debris may clog the lens of the camera and prevent accurate data acquisition.

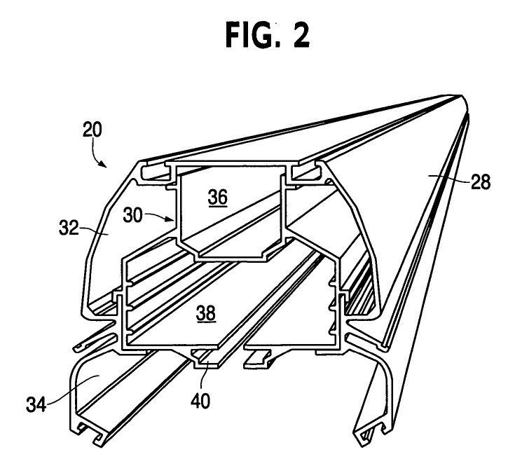

FIG. 2 is a perspective view of a track system 20 of the surveillance system 10. The track system 20 includes a first track 28 coupled to a second track 30. The first track 28 includes a passageway 32 and a rail system 34, below the passageway 32. The second track 30 includes an upper conduit 36, a middle conduit 38 and a lower conduit 40. The second track 30 is generally disposed within the first track 28. The upper conduit 36 and the middle conduit 38 are disposed within the passageway 32. The lower conduit 40 is disposed within the rail system 34.

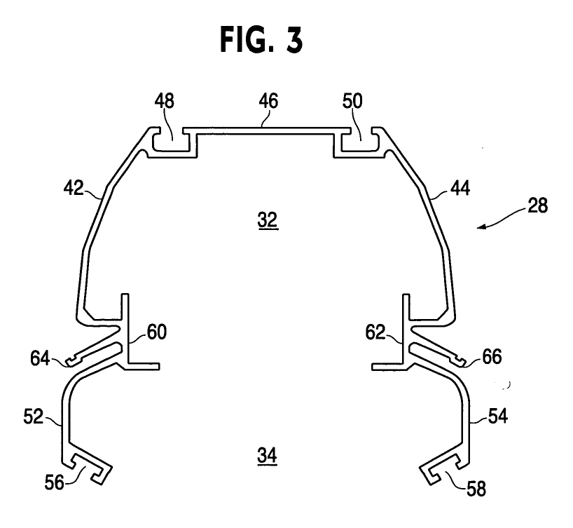

FIG. 3 is a front plan view of the first track 28. The passageway 32 of the first track 28 has a left sidewall 42, a right sidewall 44 and a top 46. The top has a C-shaped upper left slot 48 at one end and another C-shaped upper right slot 50 at its other end. These slots are used to lengthen the surveillance system 10 by combining several track systems 20 together. The upper left slot 48 and the upper right slot 50 are capable of coupling one track system 20 to another, to lengthen a span of the surveillance system 10. Brackets may be used to couple these slots together. The left sidewall 42 and the right sidewall 44 are angled inwards in a direction of the passageway 32.

The rail system 34 has a left sidewall 52 and a right sidewall 54. An upper portion 60 of the left sidewall 52 and an upper portion 62 of the right sidewall 54 form opposing L-shaped seats for coupling to the second track 30. The left sidewall 52 and the right sidewall 54 also have a left dome notch 64 and a right dome notch 66, respectively, for coupling the dome 22 to the first track 28.

In addition, on a lower portion of the left sidewall 52 and the right sidewall 54 are a lower left slot 56 and a lower right slot 58. Along with the upper left slot 48 and the upper right slot 50, the lower left slot 56 and the lower right slot 58 are used for coupling one track system 20 to another to lengthen the span of the surveillance system 10. The lower left slot 56 and the lower right slot 58 are also C-shaped and are angled in a non-perpendicular direction away from the rail system 34. Although a non-perpendicular direction is indicated, a perpendicular configuration may also be used.

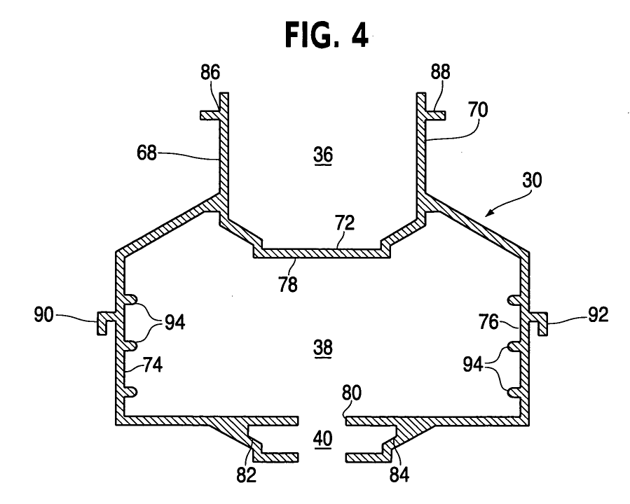

FIG. 4 is a front plan view of a second track 30 in accordance with one embodiment of the invention. The second track 30 has the upper conduit 36, the middle conduit 38 and the lower conduit 40. Although, stated as upper 36, middle 38 and lower 40 conduits, the conduits may be fashioned of unitary construction or be fashioned separately and attached together by any suitable means as is convenient. The upper conduit 36 has a left sidewall 68, a right sidewall 70 and a bottom 72. The middle conduit 38 has a left sidewall 74, a right sidewall 76, a top 78 and a bottom 80. The bottom 72 of the upper conduit 36 is adjacent the top 78 of the middle conduit 38. The lower conduit 40 also has a left sidewall 82 and a right sidewall 84. The left sidewall 82 and the right sidewall 84 are angled inwards in a direction toward the lower conduit 40 and form opposing U-shapes. The upper conduit 36 and the lower conduit 40 permit a belt (discussed in greater detail in a subsequent paragraph) to travel across the surveillance system 10. The middle conduit 38 houses the various wires required to transmit power, audio and video signals.

The second track 30 couples to the first track 28 at several locations. In particular, the left sidewall 68 and the right sidewall 70 of the upper conduit 36 have a left seat 86 and a right seat 88, respectively. The left seat 86 and the right seat 88 form L-shaped seats that face away from each other. The left seat 86 attaches to the upper left slot 48 of the first track 28. Correspondingly, the right seat 88 attaches to the upper right slot 50 of the first track 28.

In addition, the middle conduit 38 has a left notch 90 and a right notch 92 on its left sidewall 74 and its right sidewall 76, respectively. The left notch 90 couples with the upper portion 60 of rail system 34 while the right notch 92 couples with the upper portion 62 of the rail system 34. Furthermore, the middle conduit 38 dampens and insulates against vibration by providing ribs 94 that are spaced along the inside of and perpendicular to the left sidewall 74 and the right sidewall 76. The ribs allow for a smaller surface area than the left sidewall 74 and the right sidewall 76. The lower surface area results in less contact, and thus less friction and noise are created by objects located therein, such as but not limited to a housing for various cables.

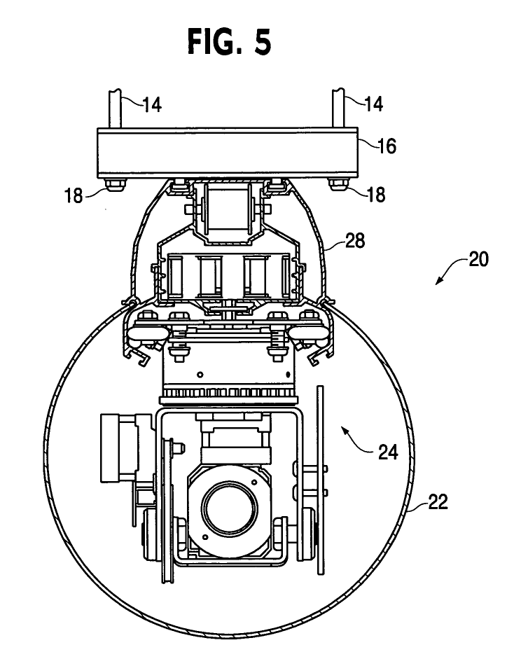

FIG. 5 illustrates a front plan view of the surveillance system 10. The first and second tracks, 28 and 30, respectively, and the camera carriage 24 may be formed of lightweight materials such as aluminum or plastic. The surveillance system 10, as per an embodiment of the invention is less expensive to manufacture and is light weight.

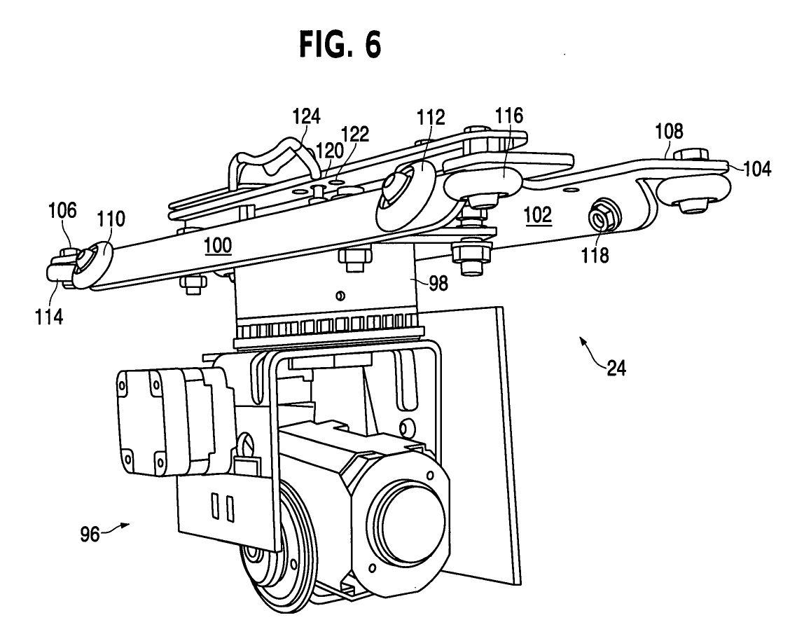

FIG. 6 is a perspective view of the camera carriage 24. The camera carriage 24 has a camera system 96 capable of panning and rotating in any direction as desired by an operator. The camera system 96 is coupled to a slip ring 98, which is coupled to the camera carriage 24.

The slip ring 98 is an electromechanical device that allows the transmission of power and electrical signals from a stationary to a rotating structure. The slip ring 98 provides un-restrained, intermittent or continuous rotation while transmitting power or data.

Any type of camera system 96 may be used such that the camera system 96 is capable of a variety of movement. Preferably the camera system 96 is capable of rotating, tilting and panning. This rotation allows the camera system 96 a variety of movement options.

In particular, the camera carriage 24 has a left sidewall 100, a right sidewall 102 and a top 104. The left sidewall 100 and the right sidewall 102 are angled at an angle less than 90 degrees from the horizontal. However, an angle of 90 degrees or greater may also be used. The camera carriage 24 has a first end 106 and a second end 108. The camera carriage 24 translates along the track system 20 by way of wheels located on the camera carriage 24. This angle of the left sidewall 100 and the right sidewall 102 allows for the wheels to center the camera carriage 24 onto the track system 20. Further, the wheels help align the camera carriage 24 within the track system 20 and reduce or prevent excessive vibration resulting from the translation of the camera carriage 24 along the track system 20. Specifically, gravity acts on the wheels to keep the camera carriage 24 aligned properly. The wheels may be formed of any suitable material, particularly a hard rubber material.

Specifically, there is a first wheel 110 on the left sidewall 100 towards the first end 106 and a second wheel 112 on the left sidewall 100 towards the second end 108. As the left sidewall 100 is positioned at an angle from the top 104, the first wheel 110 and second wheel 112 are also at such an angle. There is a third wheel 114 disposed on the top 104 towards the first end 106 and a fourth wheel 116 disposed on the top 104 towards the second end 108. As mentioned previously, wheels 110 and 112 help to align the camera carriage 24 vertically and reduce or prevent vertical shifts in the camera carriage 24 along the track system 20. In corresponding manner, wheels 114 and 116 align the camera carriage 24 horizontally and reduce or prevent lateral shifts in the camera carriage 24 along the track system 20.

There are additional wheels placed in a corresponding manner on the opposing side of the top 104 at either ends and on the right sidewall 104 of the camera carriage 24. The wheels ride along the rail system 34. In particular wheels 114 and 116 ride along the left sidewall 52 and the right sidewall 54 of the rail system 34. Wheels 110 and 112 ride along the lower portion of the left sidewall 52 and the right sidewall 54. In like manner, the wheels on the other side of the top 104 at either ends and on the right sidewall 104 of the camera carriage 24 ride along the rail system 34.

The wheels are attached to the camera carriage by way of fasteners 118. The fasteners 118 may be any type of fastener, such as for example, a screw or bolt. In addition, the camera carriage 24 has a bracket 120 located above the top 104. The bracket has openings 122 for cables 124. Cables 124 may be data, power or audio/video cables, or any such cable as may be required.

The operator may control the movement of the camera carriage 24 such that the operator can choose where the camera carriage 24 is positioned on the length of the surveillance system 10. The operator can move the camera carriage 24 forward, backward or place the camera carriage 24 anywhere along the expanse of the surveillance system 10. Further, the operator can also control the operation of the camera system 96. The camera system 96 may be panned, tilted or rotated in any direction as desired.

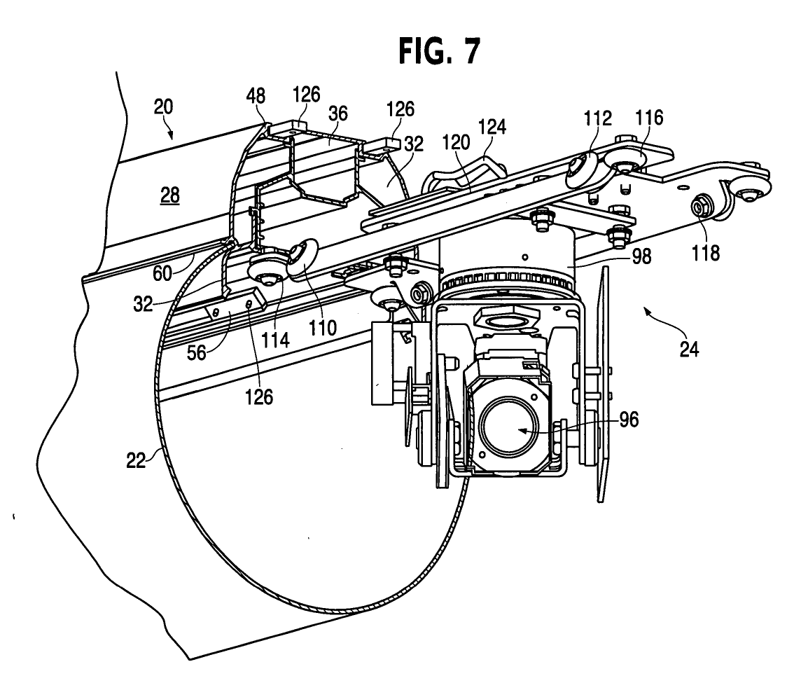

FIG. 7 is a perspective view of the camera carriage 24 coupled to the track system 20. In particular, the bracket 120 of the camera carriage 24 couples to the lower conduit 40 of the second track 30. The wheels of the camera carriage 24 rotate along the rail system 34. For example, wheels 114 and 116 rotate against the left sidewall 52 of the rail system 34 while wheels 110 and 112 rotate adjacent the lower left slot 58. Correspondingly, wheels on the other side of the camera carriage 24 rotate against the right sidewall 54 and adjacent the lower right slot 58 of the rail system 34.

This figure also illustrates how the surveillance system 10 may be lengthened or shortened as desired. Brackets 126 couple the upper left slot 48 of one track system 20 to the upper left slot 48 of another track system 20. In like manner, the upper right slot 50 is coupled by a bracket 126 to the upper right slot 50 of another track system. The lower left slot 56 and the lower right slot 58 are also coupled in such a manner. Thus, the surveillance system 10 may be customized to any length by combining several track systems together. Similarly, several smaller sections of the dome 22 may be combined to lengthen the expanse of the dome 22. Although, brackets 126 are shown, the surveillance system 10 may be lengthened or shortened in other ways as may be convenient.

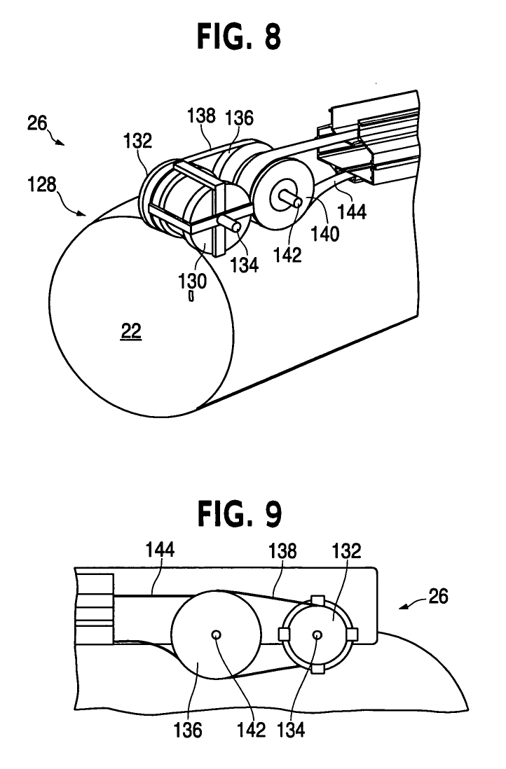

FIG. 8 is a perspective view of one aspect of the pulley system 26. This aspect of the pulley system is at a first end 128 of the surveillance system 10. At the first end 128, the pulley system 26 contains a motor 130 coupled to a first pulley 132. The motor 130 and the first pulley 132 are coaxial about a first shaft 134. The motor 130 provides the power to translate the camera carriage 24 across the surveillance system 10. A second pulley 136 is coupled to the first pulley 132 via a first belt 138 to transmit the power. The second pulley 136 is coupled to a third pulley 140. The second pulley 136 and the third pulley 140 are coaxial about a second shaft 142. The third pulley 140 is connected by a second belt 144 to a second end 146 of the surveillance system 10. FIG. 9 is a side plan view of the first end 128 of the surveillance system 10.

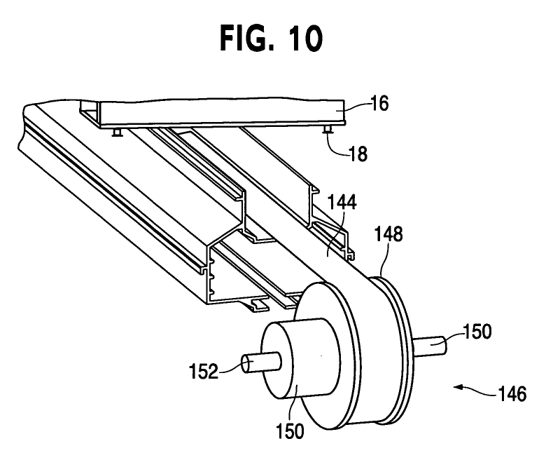

FIG. 10 is a perspective view of the second end 146 of the surveillance system 10. The second belt 144 spans the length of the surveillance system 10 and couples the third pulley 140 to a fourth pulley 148 located at the second end 146. The fourth pulley 140 is coupled to an encoder 150. The fourth pulley 140 and the encoder 150 are coaxial about a third shaft 152. The second belt 144 couples to the camera carriage 24 and translates it across the surveillance system 10.

The encoder 150 internally includes a rotating disk, a light source and a photodetector or light sensor. These components (not shown) enable the encoder 150 to measure the distance the camera carriage 24 has traveled along the surveillance system 10. The disk, mounted on a rotating shaft such as the third shaft 152, has coded patterns of opaque and transparent sectors. As the disk rotates, these patterns interrupt the light emitted onto the photodetector, generating a digital or pulse signal output.

Thus, the encoder's 150 rotation is associated with a particular distance along the length of the surveillance system 10. For example, a length of one foot may be associated with one rotation of the encoder 150. Thus, when the encoder 150 rotates five times, the operator will know that the camera carriage 24 has traveled five feet along the surveillance system 10. Thus, the encoder 150 translates rotation into distance.

Although shown on the second end 146 of the surveillance system 10, the encoder 150 may be placed anywhere on the surveillance system 10 as desired, including the first end 128 of the surveillance system 10.

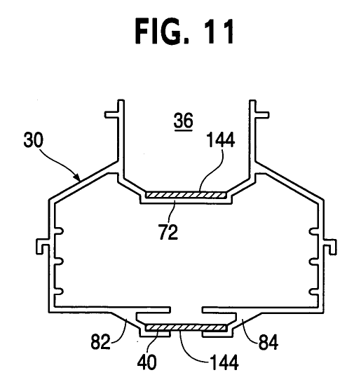

FIG. 11 is a front plan view of the pulley system 26. In particular this figure illustrates the location of the second belt 146 within the surveillance system 10. The second belt 144 is supported by the second track 30. Part of the second belt 144 translates against the bottom 72 of the upper conduit 36 of the second track 30. Another part of the second belt 144 is supported within the lower conduit 40 between the C-shaped left sidewall 82 and the right sidewall 84. In this manner the second belt 144 is supported and results in little or no sagging.

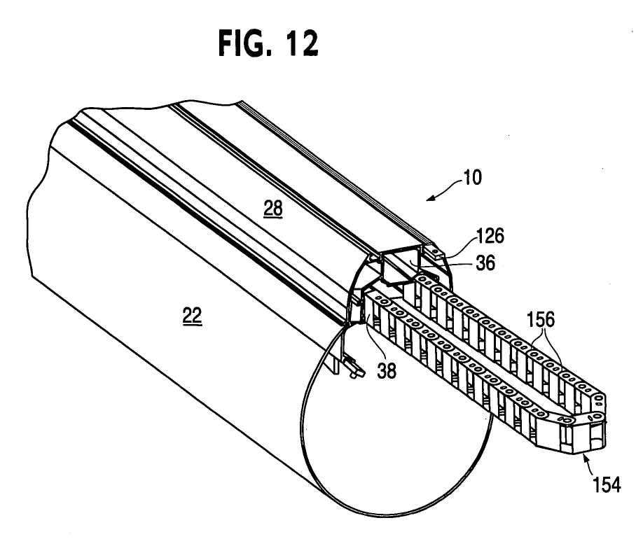

FIG. 12 is a perspective view of the housing 154 for the cables 124 of the surveillance system. The housing 154 consists of hollow I-shaped links 156. The housing 154 is disposed within the middle conduit 38 of the second track 30. The housing 154 is coupled to the camera carriage 24 and translates along the surveillance system 10 along with the camera carriage 24. The ribs 94 along the left sidewall 74 and right sidewall 76 of the middle conduit 38 prevent or lower vibration that results when the housing 154 translates within the middle conduit 38. The vibration can be movement or noise, for example. The low surface area of the ribs 94 provide for less contact between the housing 154 and the middle conduit 38, reducing vibration.

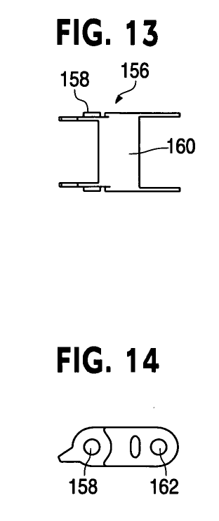

FIG. 13 is a detailed side plan view of the link 156. The link 156 has a notch 158 for coupling to another link and a hollow stem 160 through which the cables 124 can be housed. FIG. 14 is a top plan view of the link 156. The link 156 has an opening 162 for accepting the notch 158 of another link 156. In this manner, the housing 154 may be lengthened or shortened to any length. Thus, the length of the housing 154 may be as customizable as the surveillance system 10. The housing 154 provides a rigid structure for moving and housing the cables 124, while being capable of expansion.

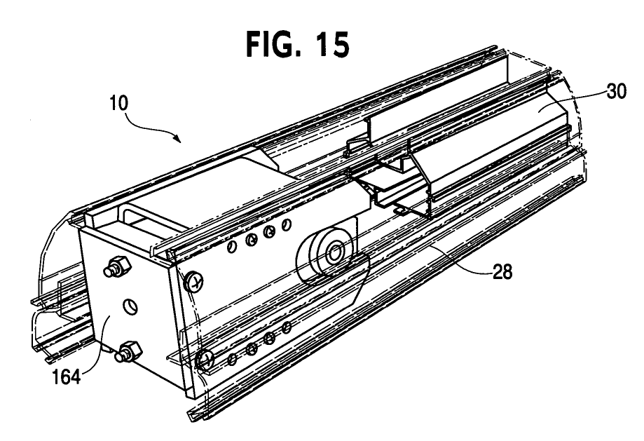

FIG. 15 is a perspective view of a counterweight 164 used with the surveillance system 10. The counterweight 164 serves to keep the belt 144 of the pulley system 26 taut and prevents excessive slack from entering into the pulley system 26. The counter weight 164 is disposed within track 28, in an axial relationship to the second track 30.

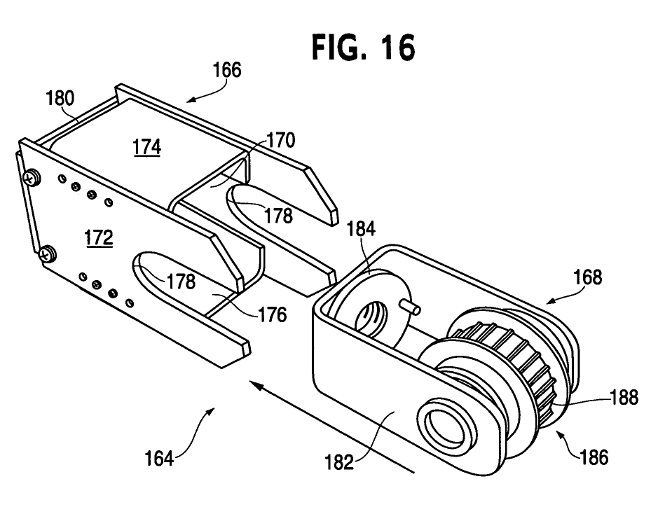

FIG. 16 is a perspective view of the assembly of the counterweight 164. In particular, the counterweight 164 includes a fixed portion 166 and a mobile portion 168. The mobile portion 168 moves axially with respect to the fixed portion 166 as a result of the belt 144. In an embodiment of the present invention, the mobile portion 168 fits within the fixed portion 166. The mobile portion 168 reduces slack in the pulley system 26 by keeping the belt 144 taut.

The fixed portion 166 has a first sidewall 170 and a second sidewall 172. The sidewalls 170 and 172 are coupled to each other by a top 174 and a bottom 176. The top 174 and bottom 176 generally have a U-shape configuration, enabling their attachment to the sidewalls 170 and 172. The sidewalls 170 and 172 have cutouts 178 at one end in a direction away from a back wall 180. The back wall 180 is also coupled to the sidewalls 170 and 172.

The mobile portion 168 has a bracket 182, generally of unitary construction, and U-shape configuration. The bracket 182 has a first damper 184 at its closed end. Further, the mobile portion 168 has a spool-like disk 186 configured to attach to the belt 144.

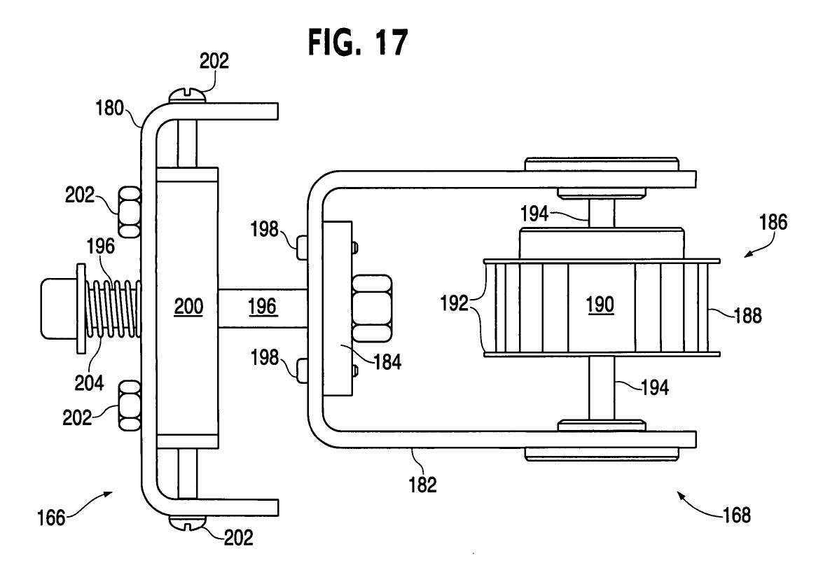

FIG. 17 is a top view of the counterweight 164 at a first position. This view shows the fixed portion 166 coupled to the mobile portion 168. Further, the disk 186 has a groove 188 to accommodate the belt 144. The groove 188 is formed by a cylinder 190 and two rims 192 affixed at each end of the cylinder 190. The rims 192 have a diameter greater than that of the cylinder 190. The rims 192 constrain the belt 144 within the groove 188 and prevent the belt 144 from slipping off the cylinder 190. The groove 188 further aligns the belt 144 and keeps the belt 144 on the disk 186.

The disk 186 comprising the cylinder 190 and the rims 192 may be of unitary construction or may be formed from separate pieces being affixed together. The mobile portion 168 uses a shaft 194 to couple the disk 186 to the bracket 182. In an embodiment of the present invention, the encoder 150 may also be coupled to the shaft 194. In particular, the encoder 150 may be coupled coaxially with the disk 186 inside the bracket 182.

The mobile portion 168 is coupled to the fixed portion 166 by way of a fastener 196. The first damper 184 is coupled to the bracket 182 by way of fasteners 198. The fasteners 196 and 198 may be any type of fastening device, such as a screw or bolt. The fixed portion 166 has a second damper 200 attached to the back wall 180 by way of various fasteners 202.

The fixed portion 166 also has a spring 204 affixed to the fastener 196. As the belt 144 acts on the disk 186 and exerts axial forces on the disk 186, the mobile portion 168 is axially translated in a corresponding manner. However, the fastener 196 and the spring 204, while allowing some movement of the mobile portion 168, prevent the mobile portion 168 from becoming disengaged from the counterweight 164.

The first and second dampers, 184 and 200, respectively, are made of any suitable plastic or rubber. They, along with the spring 204, cushion against contact between the mobile portion 168 and the fixed portion 166. They also reduce vibration and noise as the pulley system 26 translates the camera carriage 24 across the surveillance system 10.

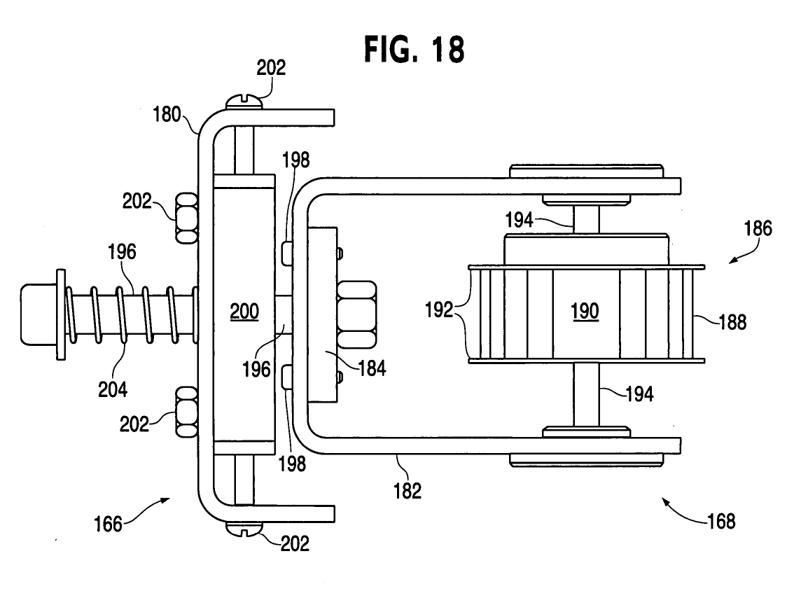

FIG. 18 is a top view of the counterweight 164 at a second position. In particular, the mobile portion 168 is closer to the fixed portion 166 and the bracket 182 is nearly adjacent the second damper 196. By no means limiting, this figure serves to illustrate the axial movement of the mobile portion 168 in relation to the fixed portion 166. Thus, the mobile portion 168 may be at any distance from the fixed portion 168. However, the distance between the mobile portion 168 and the fixed portion 166 will be defined by the length of the fastener 196.

As the mobile portion 168 translates axially, the spring 204 compresses and extends depending on the movement of the mobile portion 168 preventing excessive movement of the mobile portion 168. Thus, when the mobile portion 168 is close to the fixed portion, the spring 204 expands as in FIG. 18. In a corresponding manner, the spring 204 contracts when the mobile portion 168 is further away from the fixed portion 166, as in FIG. 17. Thus the tension in the spring 204 acts to keep the belt 144 taut if there is too much slack and provides some slack if the belt 144 is too taut. Thus, the spring 204 adjusts along with the mobile portion 168 depending on the tension of the belt 144 in the pulley system 26.

A surveillance system 10 as previously discussed may be used anywhere surveillance or recording is desired. Examples include the retail industry, such as stores or warehouses, to monitor and deter theft. Further, the surveillance system 10 may be used for security purposes, such as for example, at airports, train stations or even on streets. Thus, the surveillance system 10 has broad application.

Affixing the surveillance system 10 is quick and easy. The surveillance system 10 may be affixed to any ceiling using the ceiling fixture 12 as discussed previously. The surveillance system 10 may also be affixed to a wall or other similar structure by configuring the ceiling fixture 12 accordingly. For example, the ceiling fixture 12, may be rotated, at a 90° angle using additional brackets or the like.

Once the surveillance system 10 has been placed in its application, for the length as desired, the camera carriage 24 may be translated across the surveillance system 10 as previously discussed. The camera carriage 24 may be configured to travel from one end to the other automatically. Alternately, it may be translated to any length as desired by an operator. In addition, the camera carriage 24 may only travel a particular span of the surveillance system 10, as desired.

The camera system 96 will capture and relay back to the operator the images it captures, using the data cables 124. The camera system 96 may be configured at a particular angle to capture images at a particular range. Alternately, the camera system 96 may be rotated, tilted or panned as desired.

As the camera carriage 24 is translated along the surveillance system 10, it can be seen that the second belt 144 is thusly translated along the length of the surveillance system 10, along with the housing 154, the data/power cables 124 and the second belt 144.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A first segment apparatus for aiding in providing surveillance in a specified area comprising:
a first track that comprises a passageway and a rail system; and
a second track comprising an upper conduit, a middle conduit and a lower conduit, wherein the second track is positioned within the passageway and detachably coupled to the first track.

2. The apparatus as in claim 1, wherein the passageway is configured with a right side wall, a left sidewall and a top.

3. The apparatus as in claim 2, wherein the right sidewall and the left sidewall of the passageway are angled in a direction of the passageway.

4. The apparatus as in claim 2, wherein the top of the passageway comprises an upper left slot at a first side of the top and an upper right slot at a second side of the top.

5. The apparatus as in claim 1, wherein the rail system is configured with a left sidewall and a right sidewall.

6. The apparatus as in claim 5, wherein an upper portion and a lower portion of the rail system left sidewall and an upper portion and a lower portion of the rail system right sidewall are angled in a direction of the rail system.

7. The apparatus as in claim 6, wherein the lower portion of the rail system right sidewall comprises a lower right slot and the lower portion of the rail system left sidewall comprises a lower left slot.

8. The apparatus as in claim 6, wherein the upper portion of the right sidewall and the upper portion of the left sidewall of the rail system are configured to detachably couple to the second track.

9. The apparatus as in claim 8, wherein the upper portion of the rail system forms an L shaped seat.

10. The apparatus as in claim 9, wherein the middle conduit comprises a notch for coupling with the L shaped seat of the upper portion of the rail system.

11. The apparatus as in claim 9, wherein the middle conduit is detachably coupled to the L shaped seat.

12. The apparatus as in claim 3, wherein the passageway left sidewall and the passageway right sidewall are configured to detachably couple to a dome.

13. The apparatus as in claim 12, wherein the left sidewall and the right sidewall comprise a dome notch that is configured to mate with the dome.

14. The apparatus as in claim 13, wherein the dome notch is adjacent an upper portion of a sidewall of the rail system.

15. The apparatus as in claim 14, wherein the dome notch is located between a sidewall of the passageway and a sidewall of the rail system.

16. The apparatus as in claim 3, wherein the passageway left sidewall is coupled to a left sidewall of the rail system and the passageway right sidewall is coupled to a right sidewall of the rail system.

17. The apparatus as in claim 1, wherein the upper conduit comprises a right sidewall, a left sidewall and a bottom.

18. The apparatus as in claim 1, wherein the lower conduit comprises a right sidewall and a left sidewall.

19. The apparatus as in claim 18, wherein the right sidewall and the left sidewall are angled in a direction of the lower conduit.

20. The apparatus as in claim 1, wherein the middle conduit comprises a right sidewall, a left sidewall, a top and a bottom.

21. The apparatus as in claim 20, wherein the middle conduit is configured to house a cable.

22. The apparatus as in claim 21, wherein the cable is selected from the group consisting of a power cable, a data cable, an audio cable, and a video cable.

23. The apparatus as in claim 21, wherein the cable is housed in a protective housing.

24. The apparatus as in claim 23, wherein the protective housing is a hollow link having an I-shape.

25. The apparatus as in claim 23, wherein the protective housing is a plurality of interlocking hollow links, wherein the links have an I-shape.

26. The apparatus as in claim 20, wherein the right sidewall and the left sidewall of the middle conduit comprise a vibration insulator.

27. The apparatus as in claim 26, wherein the vibration insulator is a rib.

28. The apparatus as in claim 27, wherein the rib protrudes in a direction of the middle conduit.

29. The apparatus as in claim 1, wherein the first segment further comprises a camera carriage.

30. The apparatus as in claim 29, wherein the camera carriage is slidably connected to the first segment.

31. The apparatus as in claim 29, wherein the camera carriage comprises at top, a right sidewall and a left sidewall.

32. The apparatus as in claim 31, wherein the top is coupled to a flange.

33. The apparatus as in claim 32, wherein the flange is connected to the lower conduit.

34. The apparatus as in claim 31, wherein the right sidewall and the left sidewall non-perpendicular with the top of the camera carriage.

35. The apparatus as in claim 31, wherein the top further comprises a wheel that is rotatably attached to a sidewall of the rail system.

36. The apparatus as in claim 31, wherein the right sidewall and the left sidewall of the camera carriage comprise a wheel that is rotatably attached to a lower portion of the rail system.

37. The apparatus as in claim 31, wherein the top is configured with a camera.

38. The apparatus as in claim 37, wherein the camera carriage and the camera are enclosed by a dome.

39. The apparatus as in claim 30, wherein the camera carriage is slidably coupled to the rail system.

40. The apparatus as in claim 1, wherein a dome is detachably coupled to the first track.

41. The apparatus as in claim 40, wherein the dome is transparent.

42. The apparatus as in claim 40, wherein the dome is formed from a plastic.

43. The apparatus as in claim 41, wherein the dome is formed from glycol-modified polyethylene terephthalate (PETG).

44. The apparatus as in claim 1, wherein the first segment is configured to be coupled to a second segment.

45. The apparatus as in claim 44, wherein an upper right slot of the first segment is coupled to an upper right slot of the second segment;
wherein an upper left slot of the first segment is coupled to an upper left slot of the second segment;
wherein a lower right slot of the first segment is coupled to a lower right slot of the second segment; and
wherein a lower left slot of the first segment is coupled to a lower left slot of the second segment.

46. The apparatus as in claim 45, wherein the upper right slot of the first segment is coupled to the upper right slot of the second segment by a first bracket;
wherein the upper left slot of the first segment is coupled to the upper left slot of the second segment by a second bracket;
wherein the lower right slot of the first segment is coupled to the lower right slot of the second segment by a third bracket; and
wherein the lower left slot of the first segment is coupled to the lower left slot of the second segment by a fourth bracket.

47. The apparatus as in claim 1, wherein a camera carriage is translated along the first segment by a pulley system.

48. The apparatus as in claim 47, wherein the pulley system comprises a pulley, a belt, an encoder, and a motor.

49. The apparatus as in claim 48, wherein a first pulley and the encoder are coupled to a first shaft and wherein the first pulley and the encoder are co-axial about the shaft.

50. The apparatus as in claim 49, wherein the fist pulley, the encoder and the first shaft are at a first end of the first segment.

51. The apparatus as in claim 48, wherein the motor and a second pulley are coupled to a second shaft and wherein the motor and the second pulley are coaxial about the shaft.

52. The apparatus as in claim 51, wherein a third pulley and a fourth pulley are coupled to a third shaft and wherein the third pulley and the fourth pulley are co-axial about the shaft.

53. The apparatus as in claim 52, wherein the motor, the second pulley, the third pulley and the fourth pulley are at a second end of the first segment.

54. The apparatus as in claim 51, wherein the second pulley is coupled to the third pulley with a first belt.

55. The apparatus as in claim 51, wherein the third pulley is coupled to the first pulley with a second belt.

56. The apparatus as in claim 55, wherein the second belt is slidably coupled to the upper conduit and the lower conduit.

57. The apparatus as in claim 48, wherein the encoder comprises a disk, a light source and a light sensor.

58. The apparatus as in claim 48, wherein the encoder is configured to generate a digital or a pulse signal.

59. The apparatus as in claim 1, wherein the first segment is affixed to a surface.

60. The apparatus as in claim 59, wherein the surface is a wall or a ceiling.

61. The apparatus as in claim 59, wherein the first segment comprises a fixture system for affixing to the surface.

62. The apparatus as in claim 61, wherein the fixture system comprises a plate and an extension disposed on the plate, wherein the plate is configured to attach to the first track and wherein the extension is configured to attach to the surface.

63. The apparatus as in claim 1, wherein a counterweight coupled to the first track comprises a fixed portion and a mobile portion.

64. The apparatus as in claim 63, wherein the fixed portion comprises a first sidewall, a second sidewall, a top wall, a bottom wall and a back wall, and wherein the first and second sidewalls are parallel and the top and bottom walls are parallel.

65. The apparatus as in claim 64, wherein the first and second sidewalls have a first and second cutout, respectively.

66. The apparatus as in claim 63, wherein the mobile portion has a bracket, coupled to a disk about a shaft disposed on the bracket.

67. The apparatus as in claim 66, wherein the bracket has a U-shaped configuration.

68. The apparatus as in claim 63, wherein the fixed portion and the mobile portion are coupled to each other by a fastener and a spring disposed on the fastener.

69. The apparatus as in claim 63, wherein the mobile portion fits within the fixed portion.

70. The apparatus as in claim 63, wherein a cutout disposed on a first and second sidewall of the fixed portion engages a shaft affixed to a disk of the mobile portion.

71. The apparatus as in claim 63, wherein the counterweight is coupled to a pulley system.

72. The apparatus as in claim 71, wherein the counterweight comprises a disk coupled to a belt of the pulley system.
